(19) United States
(12) Patent Application Publication
(10) Pub. No.: US 2019/0239483 A1
(43) Pub. Date: Aug. 8, 2019

(54) Dog Urine Pad Assembly

(71) Applicant: Alex Thibault, Bristol, CT (US)

(72) Inventor: Alex Thibault, Bristol, CT (US)

(21) Appl. No.: 15/891,139

(22) Filed: Feb. 7, 2018

(51) Int. Cl. A01K 23/00

(52) U.S. Cl. CPC A01K 23/005; A01K 1/0107

(57) ABSTRACT

A dog urine pad assembly for absorbing dog urine includes a panel that is positioned on an intersection between a floor and a wall having the panel extending upwardly on the wall and horizontally along the floor. A pad is coupled to the panel and the pad is urinated on by a dog. The pad is comprised of a fluid absorbent material to absorb the urine. A plurality of mating members is provided and each of the mating members is coupled to the panel. The plurality of mating members engages the floor and the wall for retaining the panel in a selected position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to pad devices and more particularly pertains to a new pad device for absorbing dog urine.

### BRIEF SUMMARY OF THE INVENTION

An embodiment of the disclosure meets the needs presented above by generally comprising a panel that is positioned on an intersection between a floor and a wall having the panel extending upwardly on the wall and horizontally along the floor. A pad is coupled to the panel and the pad is urinated on by a dog. The pad is comprised of a fluid absorbent material to absorb the urine. A plurality of mating members is provided and each of the mating members is coupled to the panel. The plurality of mating members engages the floor and the wall for retaining the panel in a selected position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a dog urine pad assembly according to an embodiment of the disclosure.

FIG. 2 is a bottom view of an embodiment of the disclosure.

FIG. 3 is a cross sectional view taken along line 3-3 of FIG. 2 of an embodiment of the disclosure.

FIG. 4 is a right side view of an embodiment of the disclosure.

FIG. 5 is a perspective in-use view of an embodiment of the disclosure.

### DETAILED DESCRIPTION OF THE INVENTION

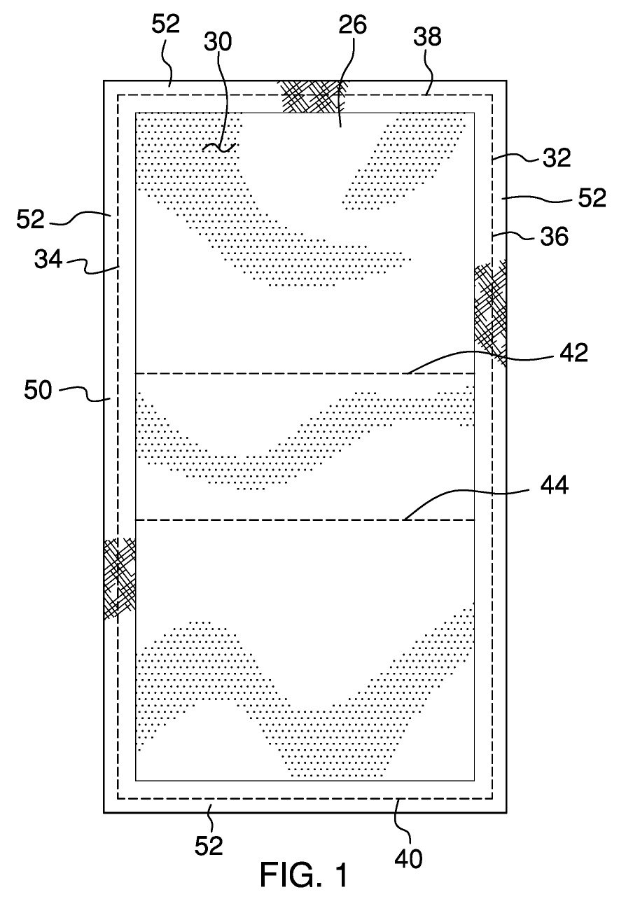

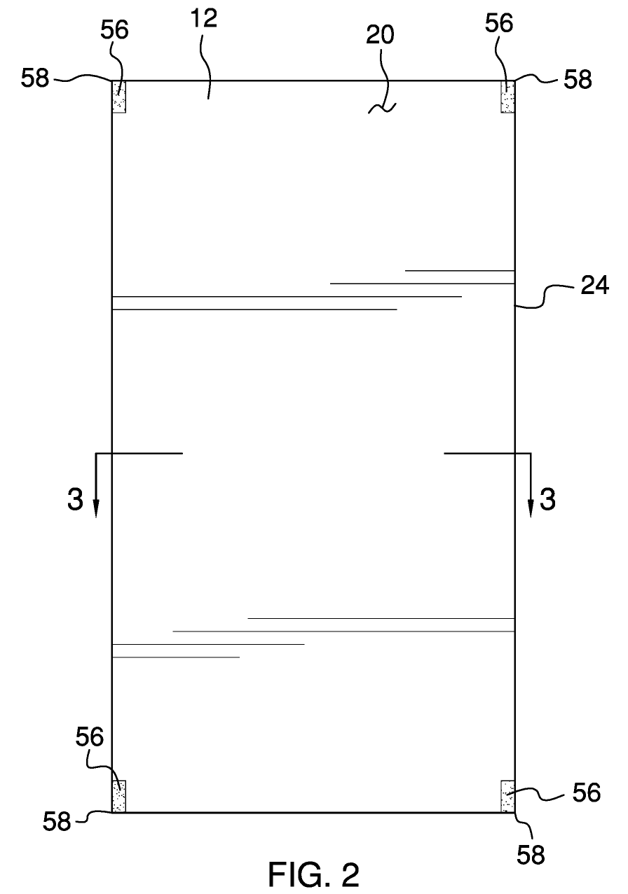

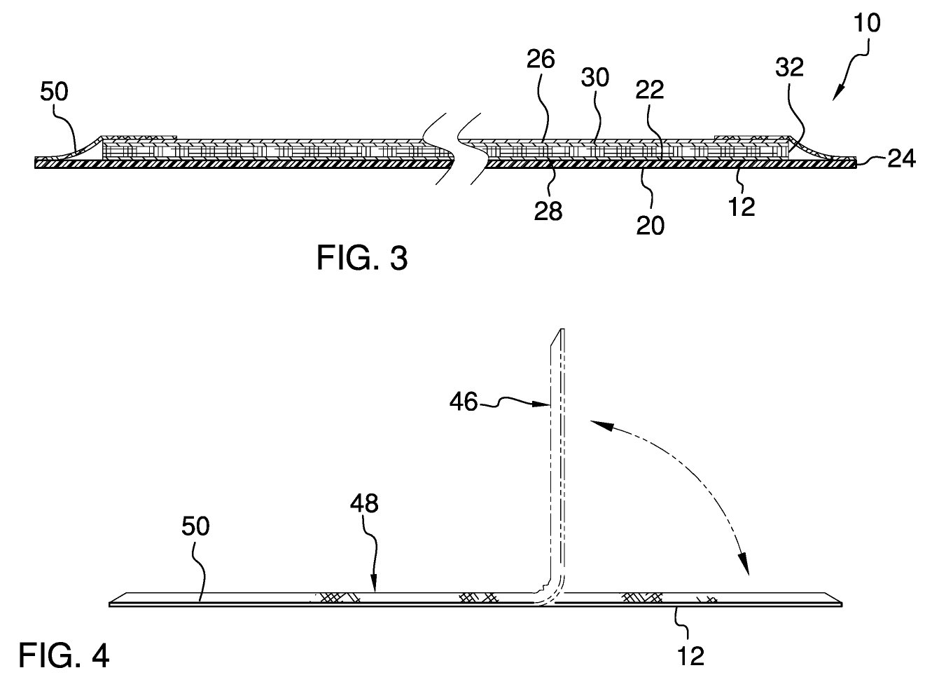

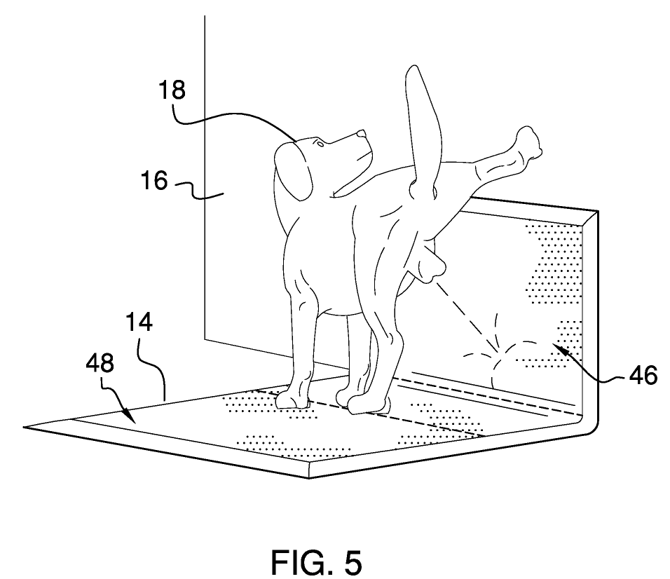

With reference now to the drawings, and in particular to FIGS. 1 through 5 thereof, a new pad device embodying the principles and concepts of an embodiment of the disclosure and generally designated by the reference numeral 10 will be described.

As best illustrated in FIGS. 1 through 5, the dog urine pad assembly 10 generally comprises a panel 12 that may be positioned on an intersection between a floor 14 and a wall 16. The panel 12 is positioned to extend upwardly on the wall 16 and horizontally along the floor 14. Each of the floor 14 and the wall 16 may be structural elements of a house or other building that is occupied by a dog 18. The panel 12 has a first surface 20, a second surface 22 and a perimeter edge 24 extending therebetween and the first surface 20 abuts the floor 14 and the wall 16. The panel 12 may have a width of at least 55.0 cm and a length of at least 100.0 cm.

A pad 26 is provided and the pad 26 is coupled to the panel 12 such that the pad 26 is urinated on by the dog 18. The pad 26 is comprised of a fluid absorbent material to absorb the urine. The pad 26 has a primary surface 28, a secondary surface 30 and a peripheral edge 32 extending therebetween. The primary surface 28 is bonded to the second surface 22 of the panel 12 and the peripheral edge 32 is spaced inwardly from and is coextensive with the perimeter edge 24 of the panel 12. The peripheral edge 32 has a first lateral side 34, a second lateral side 36, a front side 38 and a back side 40.

The pad 26 has a first fold 42 extending between the first lateral side 34 and the second lateral side 36 and the first fold 42 is positioned closer to the front side 38 than the back side 40. Additionally, the first fold 42 may be spaced from the front side 38 a distance of approximately 40.0 cm. The pad 26 has a second fold 44 extending between the first lateral side 34 and the second lateral side 36 and the second fold 44 is positioned between the first fold 42 and the back side 40. The second fold 44 may be spaced from the back side 40 a distance of approximately 40.0 cm.

Each of the panel 12 and the pad 26 is foldable along a selected one of the first fold 42 and the second fold 44 to define a wall portion 46 of the panel 12 and pad 26 and a floor portion 48 of the panel 12 and pad 26. The wall portion 46 extends upwardly on the wall 16 and the floor portion 48 extends away from the wall 16 on the floor 14. In this way the pad 26 absorbs the urine when the dog 18 urinates on the wall 16, on the floor 14 and on the intersection of the wall 16 and the floor 14. Additionally, the pad 26 may be infused with a chemical scent that attracts the dog 18 to urinate on the pad 26.

A border 50 is provided and the border 50 is coupled between the panel 12 and the pad 26. The border 50 has a plurality of intersecting sides 52 such that the border 50 has a rectangular shape. The border 50 has a first surface 54 and the first surface 54 of the border 50 is coupled to the second surface 22 of the panel 12 and the secondary surface 30 of the pad 26. Additionally, the border 50 is coextensive with the perimeter edge 24 of the panel 12 and the border 50 extends inwardly from the perimeter edge 24 beyond the peripheral edge 32 of the pad 26.

A plurality of mating members 56 is provided and each of the mating members 56 is coupled to the panel 12. The plurality of mating members 56 engages the floor 14 and the wall 16 for retaining the panel 12 in a selected position. Each of the mating members 56 is positioned on the first surface 20 of the panel 12 and each of the mating members 56 is aligned with an associated one of four corners 58 of the panel 12. Moreover, each of the mating members 56 may comprise an adhesive strip or the like for adhering to the floor 14 and the wall 16.

In use, the pad 26 is folded along a selected one of the first 42 and second 44 folds to define the floor portion 48 of the panel 12 and pad 26 and the wall portion 46 of the panel 12 and pad 26. The wall portion 46 of the panel 12 is abutted against the wall 16 and the floor portion 48 of the panel 12 rests on the floor 14. In this way the pad 26 extends upwardly along the wall 16 and away from the wall 16 on the floor 14. The pad 26 absorbs the urine from the dog 18 when the dog 18 stands on the pad 26 to urinate on the floor 14 or the wall 16. In this way the pad 26 inhibits the urine from contacting the floor 14 and the wall 16. The panel 12 is deployed while the dog 18 is being house trained thereby reducing the need to clean up urine on the wall 16 and the floor 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dog urine pad assembly being configured to be positioned on an intersection of a wall and a floor for absorbing urine from a dog, said assembly comprising:
a panel being configured to be positioned on an intersection between a floor and a wall having said panel extending upwardly on the wall and horizontally along the floor;
a pad being coupled to said panel wherein said pad is configured to be urinated on by a dog, said pad being comprised of a fluid absorbent material wherein said pad is configured to absorb the urine; and
a plurality of mating members, each of said mating members being coupled to said panel wherein said plurality of mating members is configured to engage the floor and the wall for retaining said panel in a selected position.

2. The assembly according to claim 1, wherein:
said panel has a first surface, a second surface and a perimeter edge extending therebetween, said first surface being configured to abut the floor and the wall; and
said pad has a primary surface, a secondary surface and a peripheral edge extending therebetween, said primary surface being bonded to said second surface of said panel, said peripheral edge being spaced inwardly from and being coextensive with said perimeter edge of said panel, said perimeter edge of said pad having a first lateral side, a second lateral side, a front side and a back side.

3. The assembly according to claim 2, wherein said pad has a first fold extending between said first lateral side and said second lateral side, said first fold being positioned closer to said front side than said back side.

4. The assembly according to claim 3, wherein said pad has a second fold extending between said first lateral side and said second lateral side, said second fold being positioned between said first fold and said back side.

5. The assembly according to claim 4, wherein said pad is foldable along a selected one of said first fold and said second fold to define a wall portion of said pad and a floor portion of said pad, said wall portion being configured to extend upwardly on the wall, said floor portion being configured to extend away from the wall on the floor.

6. The assembly according to claim 2, further comprising a border being coupled between said panel and said pad, said border having a plurality of intersecting sides such that said border has a rectangular shape, said border having a first surface, said first surface being coupled to said second surface of said panel and said secondary surface of said pad.

7. The assembly according to claim 6, wherein said border is coextensive with said perimeter edge of said panel, said border extending inwardly from said perimeter edge beyond said peripheral edge of said pad.

8. A dog urine pad assembly being configured to be positioned on an intersection of a wall and a floor for absorbing urine from a dog, said assembly comprising:
a panel being configured to be positioned on an intersection between a floor and a wall having said panel extending upwardly on the wall and horizontally along the floor, said panel having a first surface, a second surface and a perimeter edge extending therebetween, said first surface being configured to abut the floor and the wall;
a pad being coupled to said panel wherein said pad is configured to be urinated on by a dog, said pad being comprised of a fluid absorbent material wherein said pad is configured to absorb the urine, said pad having a primary surface, a secondary surface and a peripheral edge extending therebetween, said primary surface being bonded to said second surface of said panel, said peripheral edge being spaced inwardly from and being coextensive with said perimeter edge of said panel, said perimeter edge having a first lateral side, a second lateral side, a front side and a back side, said pad having a first fold extending between said first lateral side and said second lateral side, said first fold being positioned closer to said front side than said back side, said pad having a second fold extending between said first lateral side and said second lateral side, said second fold being positioned between said first fold and said back side, said pad being foldable along a selected one of said first fold and said second fold to define a wall portion of said pad and a floor portion of said pad, said wall portion being configured to extend upwardly on the wall, said floor portion being configured to extend away from the wall on the floor;
a border being coupled between said panel and said pad, said border having a plurality of intersecting sides such that said border has a rectangular shape, said border having a first surface, said first surface being coupled to said second surface of said panel and said secondary surface of said pad, said border being coextensive with said perimeter edge of said panel, said border extending inwardly from said perimeter edge beyond said peripheral edge of said pad; and
a plurality of mating members, each of said mating members being coupled to said panel wherein said plurality of mating members is configured to engage the floor and the wall for retaining said panel in a selected position, each of said mating members being positioned on said first surface of said panel, each of said mating members being aligned with an associated one of four corners of said panel.
